(19) United States
(12) Patent Application Publication
(10) Pub. No.: US 2026/0350173 A1
(43) Pub. Date: Nov. 5, 2026

(54) METHOD FOR MEASURING SECURITY OPERATION CENTER

(71) Applicant: BINALYZE YAZILIM A.S., Cankaya/Ankara (TR)

(72) Inventors: Emre TINAZTEPE, Cankaya/Ankara (TR); Oktay YILDIZ, Cankjaya/Ankara (TR)

(21) Appl. No.: 19/112,493

(22) PCT Filed: Sep. 23, 2022
(86) PCT No.: PCT/TR2022/051036

§ 371 Date: Mar. 17, 2025

(51) Int. Cl. G06F 21/57

(52) U.S. Cl. CPC G06F 21/577

(57) ABSTRACT

A method of digital forensics investigation suitable for a security operation center comprising at least multiple analysis entities is proposed, said operation center being configured to monitor at least one information network comprising at least multiple assets. Said method comprises steps of forensic artifact collection, compromise indicator injection, investigation rating, and readiness-based grouping.

### TECHNICAL FIELD OF THE PRESENT INVENTION

The invention presented hereby relates generally to security operations and digital forensics and incident response investigations for networks comprising multiple assets. The invention more specifically refers to methods and arrangements whereby information security operation centers that detect and handle intrusions to an information system are trained, grouped, and selected.

### PRIOR ART/BACKGROUND OF THE PRESENT INVENTION

An information security operations center (ISOC, SOC, Managed SOC) refers to a facility tasked with defending, monitoring and ensuring safety of an information system at an enterprise level, i.e. ones that may comprise databases, data centers, servers, information networks and at least multiple assets. For different purposes, a SOC may comprise different sets of skills suited for the defense according to the needs of a particular network, such as those needed to be defended from malicious entities such as APTs or insider threats.

Advanced persistent threat groups (APTs) are malicious entities/actors that, over an extended period of time, gain unauthorized access to a computer network and maintain presence in an undetected manner. Such actors may pose such threats for a variety of purposes in a wide array of sectors, namely government, legal, financial, telecommunications, defense services with the intent of disruption or long-term espionage. Such a time frame wherein APTs maintain presence in a system is called a “dwell-time”, which can range from at least a couple of months to a year when undetected.

A prominent aspect that makes these types of threats persistent is their ability of lateral movement, during which they oversee control of the infrastructure elements constituting the target computer network as a whole, at times switching assets and bolstering the extent of compromise while remaining undetected by conventional, monitoring-based cybersecurity measures.

A document known in the art, CN113343231A, discloses a data acquisition system for threat intelligence based on centralized management and control is characterized in that the threat intelligence is managed and shared in a centralized mode, the system and the data acquisition module comprise an OSINT source, a data acquisition module, a real-time data module, an IoC standardization module, a deduplication module, an IoC aggregation module, an IoC database and an IoC database, the deduplication module, the redundancy-eliminated IoC, and the IoC aggregation module aggregate different but related IoC and generate a new IoC. The process comprises the following steps of identifying the IoC containing relevant information, aggregating the IoC into the same set, merging the information into a single IoC, creating a new IoC, namely a composite IoC (cIoC) for short, and storing the new IoC in a database for sharing and using threat intelligence. According to the invention, threat intelligence can be automatically collected and cleaned, and positive security defense measures are realized.

According to the teaching of U.S. Pat. No. 10,102,379 B1, published enterprise threat detection (ETD) security notes are accessed in a computer data store. Applicability of the published ETD security notes are determined for an information technology (IT) computing landscape. A determination is made that a particular applicable ETD security note has not yet been implemented in the IT computing landscape. Aggregated impact of compromise (IoC) and state of compromise (SoC) values associated with the published ETD security note are analyzed and a computing system patching action is performed based on the aggregated IoC and SoC values. U.S. Pat. No. 10,341,367 B1 discloses methods, systems, and devices for inquiring and storing Indicator of Compromise (IoC) information. In one example, a method of inquiring and storing IoC information can include determining a target IoC information to be identified when an event occurs, requesting an encryption socket communication module of a first user terminal to request the target IoC information from an IoC information providing server, requesting a P2P socket communication module of the first user terminal to request the target IoC information from a P2P socket communication module of at least one other user terminal, and storing the target IoC information that is received first from either the IoC information providing server or the P2P socket communication module of the at least one other user terminal.

WO2020060503A1 discloses an email threat simulator (ETS), identifies security vulnerabilities in email servers and existing email protection mechanisms and automatically fix them to provide remediation services and regular testing of the technology environment. ETS is integrated with industry-leading IOCs and exploitation frameworks, as well as manual sources, to constantly maintain an up-to-date set of attack types. Using simulation logic, ETS generates an attack that sends more than 240 known and current attack vector types including ransomware, browser exploits, malicious code and attachments and file format exploits to the test mailbox and check their status. By this way, ETS allows to conduct real-world tests for cyber-security risks, instead of monitoring traffic between the server and client which is insufficient for antispam, antivirus and email services.

### OBJECTS OF THE PRESENT INVENTION

Primary objective of the disclosed invention is to present a method of measuring and improving the readiness score of a Security Operation Center or a managed security service provider tasked with investigating an alert or running continuous assessments of a group of information system assets.

Secondary objective of the disclosed invention is to present a method of providing a comprehensive skillset assessment of SOC analysis entities individually or as a group for determining their strengths and weaknesses, enabling said analysis entities to be grouped accordingly or be assigned to relevant trainings.

Third objective of the disclosed invention is to facilitate the readiness assessment process with real-world data comprised of one or multiple forensic snapshots taken from the environment SOC analysis entities are responsible for securing, and combining this with differential attack indicators to provide a realistic picture of a simulated attack.

Yet another objective of the disclosed invention is to propose a distance metric between said at least one state and at least one other state of the readiness score in a SOC for presenting the decision makers/managers with a detailed assessment report for them to decide on the areas of improvements that could be the training assignments to analysts.

Yet another object of the disclosed invention is to propose a method of simulating the presence of a cyber-attack in an information system network based on the qualitative and quantitative properties of said distance metric or the actions performed by an APT group or a malevolent employee such as the case with an insider attack.

### SUMMARY OF THE PRESENT INVENTION

Disclosed invention proposes a method for maintaining and ensuring security operations center readiness in a collection of information assets, such as an information system network. Said method is particularly envisioned towards measuring, developing, and improving readiness in security operations centers tasked with detecting, monitoring and may comprise a set of assets each able to display different characteristics, such as criticality, significance and type, based on their location and importance for said information system network.

In order to monitor and improve an organization's security posture, security operations centers are utilized which may include people, processes, and technology that enable situational awareness via the monitoring, identification, mitigation, and containment of IT risks. Any threatening IT event is to be handled by a SOC on behalf of an enterprise or institution, which makes sure that said threatening event is appropriately recognized, evaluated, communicated, investigated and reported. However, such methods and entities undertaking this task frequently fall short next to advanced persistent threats, leading to a talent war between various security contractors.

Disclosed invention is presented as a solution utilizable against advanced persistent threats or insider threats that cannot be simulated properly, timely or effectively using conventional, monitoring-based solutions known in the art. To this end, a multiplicity of indicators of compromise (IoC) which are associated with treats of persistent nature are used with forensic snapshots pertaining to assets in a network, which may be a mobile device, a personal computer, a workstation, a virtual machine, a cloud service or a cloud platform and may encompass multiple forensic states of a single state or single forensic states of multiple assets.

Further according to the disclosed invention, the method of maintaining and ensuring security operations center readiness is mainly based on hypothetical scenarios of advanced persistent threat (APT) activity, represented in snapshots that are taken from a single or multiple assets at different points in time, subsequently combined with a list of indicators of compromise, thus providing a forensic snapshot which is representative of a hypothetical situation where these indicators of compromise do exist on the assets, basically simulating an attack as if it took place inside the information system network from SOC's point of view.

According to another embodiment, the method may be based on individual snapshots that are taken from multiple assets. Said forensic snapshots comprise either pre-defined (e.g. by a “golden image” for initializing operational condition of an asset's) or user-defined properties of an asset, which may be represented in binary or text format, as well as CSV, JSON, txt or log file format. The method allows for determining what is added, changed, deleted or removed in the assets to allow for penetration, persistence or decreasing the security level of an otherwise secure system, based on difference between said forensic images.

Disclosed system and method is advantageous next to the techniques known in the art in that it specifically addresses the problem of advanced persistent threats (APTs) or insider threat investigations being able to maintain access and presence under low detectability. Via leveraging aforementioned concept of forensic snapshots merged with a list of indicators of compromise, disclosed invention is able to replace/highly improve the methods geared towards preparing virtual machines and infecting them with real world malware samples or simulating malicious user behaviors on them before providing the forensic image to an investigator to analyze.

### BRIEF DESCRIPTION OF THE FIGURES OF THE PRESENT INVENTION

Accompanying figures are given solely for the purpose of exemplifying a method of maintaining security operations center readiness, whose advantages over prior art were outlined above and will be explained in brief hereinafter.

The figures are not meant to delimit the scope of protection as identified in the claims nor should they be referred to alone in an effort to interpret the scope identified in said claims without recourse to the technical disclosure in the description of the present invention.

FIG. 1 illustrates a diagram of the method of maintaining security operations center readiness against long-term cyber incidents as described in the present invention.

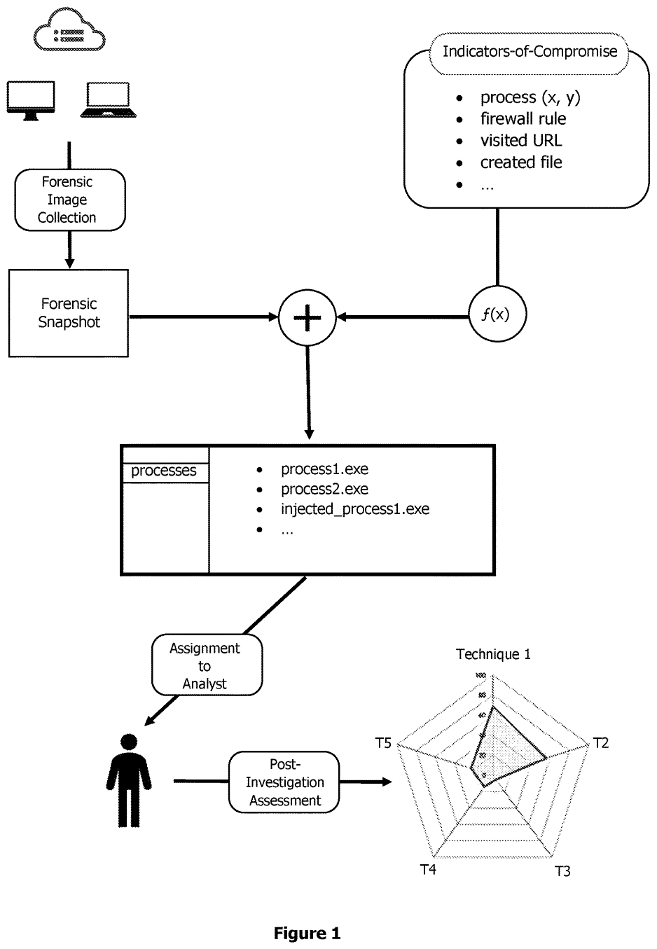

FIG. 2 illustrates a flow diagram of groupings based on skill assessments obtained by the disclosed method of maintaining security operations center readiness, for different analysis entities.

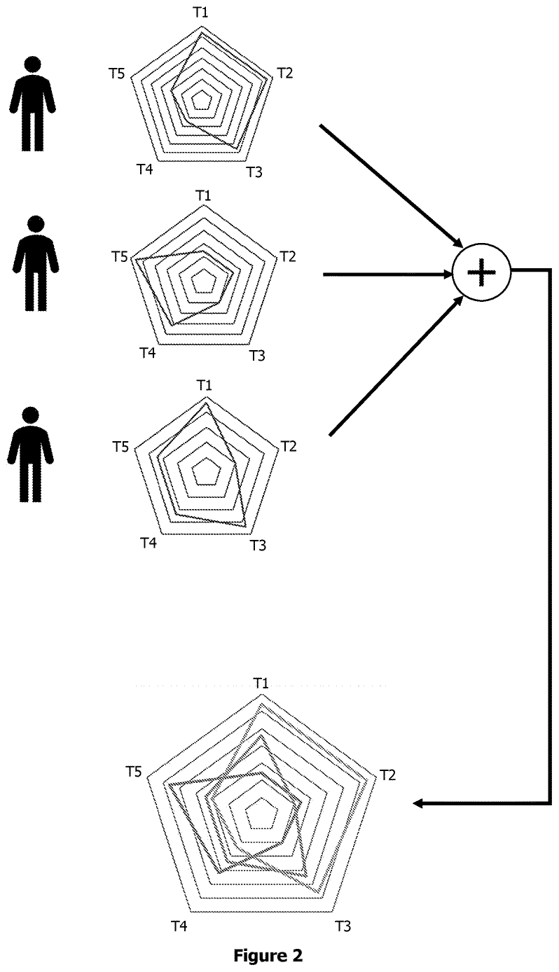

FIG. 3 illustrates a flow chart of the method of maintaining security operations center readiness against long-term cyber incidents as described in the present invention.

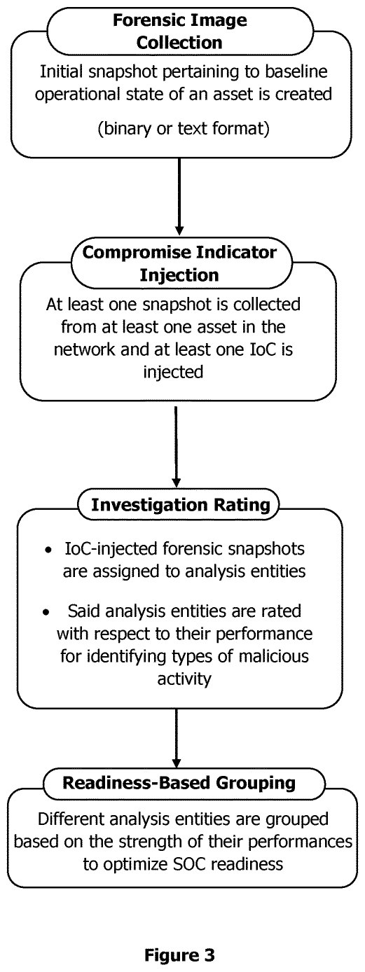

### DETAILED DESCRIPTION OF THE PRESENT INVENTION

Following is the inventive subject matter of the present disclosure. Embodiments are set forth to represent an example and not to limit the borders of the invention. Some well-known specific details of the embodiments are not necessarily elaborated.

According to an embodiment of the disclosed invention, an information network is provided. Said information system network may comprise different assets, such as individual workstations in a network in a business or information processing and sharing setting. Such assets, according to different embodiments, may be computers comprising at least one hard drive, at least one non-transitory computer readable medium, such as a random access memory (RAM). Said assets, according to different embodiments, may further be initialized based on an initial state deemed functional by the specific requirements of the information system network. Such an initial state may be generated using what is called a golden image, pertaining to a group of settings for an asset joining said network. An example of such golden images may be a compact disc (CD) contain setup settings of a personal computer given to a new employee in an enterprise, itself customizable based on the clearance level of the employee and the privileges associated with the asset used.

Presence of a malware (e.g. a ransomware, trojan, spyware) in an asset may be, depending on the properties of said asset in a given point in time, associated with a state, more specifically a forensic state. Such forensic states may reflect the extent to which said asset is compromised, deducible from the differential distance between the actual condition of the compromised asset and its respective golden image. Such a differential distance pertains to what is added, modified, removed or deleted from the forensic state considered significant and critical by the requirements and needs of said information system network's security level. Based on this, several infiltration and compromise scenarios may be formed, using data gathered from high-profile attacks by international cyber espionage groups, such as Fancy Bear, or APT28. For different scenarios, other great scale attacks consistent with the capabilities of state actors may also be considered, such as ones by LightBasin, Red Apollo, Sandworm. Such attack types may comprise exploiting zero-day vulnerabilities, spear phishing and malware drops. Such attack types are utilized by adversaries for creating and maintaining vulnerabilities in a non-neutral space, such as any targeted system that may be organized as an information system/network, gathering credentials from users of certain assets in said systems/networks, subsequently using said credentials to gain access to said system/network and maintaining presence through lateral movement and/or installing malicious files. In subsequent stages, certain data of interest may be exfiltrated over an extended period.

According to various embodiments of the disclosed invention, a method of training and maintaining security operations centers for readiness against cyber incidents is proposed. Said method is also utilizable for investigation against specific and long-term cyber incidents such as advanced persistent threats in an information system network. Said information system network may comprise at least multiple assets such as a mobile device, a computer, a virtual machine, a cloud service, or a cloud platform.

In various embodiments, said method of ensuring SOC readiness is based on snapshots that may be taken from a single asset at any given point in time. According to another embodiment, the method may be based on individual snapshots that are taken from multiple assets. Said forensic snapshots comprise either pre-defined (e.g. by a “golden image” for initializing an asset's operational condition) or user-defined properties of an asset, which may be represented in binary or text format, as well as CSV, JSON, txt or log file format. The method enables measuring the level of expertise of different entities comprised by a SOC, their alertness or their precision and keenness for detecting both different types for determining what is added, changed, deleted or removed in the assets to allow for penetration, persistence or decreasing the security level of an otherwise secure system, based on difference between said forensic images.

Additionally, merging different types of indicators of compromise with a forensic snapshot taken from the information network also enables the assessment of individual skillsets required by analysts to properly understand the level and scope of the incident on multiple verticals of an attack such as initial access, persistence, lateral movement, and more. While being able to assess the readiness level of an individual and identify where they are strong or weak at. The same method can also be used for creating a cumulative assessment score for the whole SOC.

According to at least one embodiment of the disclosed invention, said method uses initially created forensic snapshot creation. Said initially created forensic snapshots may be created on demand or retrieved from a memory location such as a storage of a certain initial snapshot, or on a scheduled basis. Said forensic snapshot contains information regarding the baseline operational state of an asset, which may be based on predetermined characteristics of the device or asset in question. Properties, clearances and operational characteristics of that specific asset or its use case can form the basis of said forensic snapshot. In several embodiments, said snapshot may be selectable from a group of binary or text formats including, but not limited to, CSV, JSON, plaintext, or log files. According to various embodiments, a collection of forensic properties of an asset may reflect the actions by different actors, either by an actual authenticated user or a malicious agent, such as modifications for processes, visited URLs, firewall rules, services, autostart items and the like.

In various aspects of the present disclosure, said forensic snapshot is configured to reflect the forensic state of an asset in said information system network. Said forensic state may be a baseline operational state created and initialized on a device with utility of a golden image, or it may alternatively be a snapshot collected at a certain point in time. Once injected with indicators of compromise, a forensic snapshot reflects an asset in a network that presents itself as if it was a part of an attack or malicious behavior. Various components of the entities making up the SOC are expected to determine the nature of said threat as evident from the forensic snapshot, now containing the injected IoCs for simulating various attack scenarios designated under MITRE ATT&CK framework that is based on real-world observations pertaining to cyberattacks and techniques they are treated with.

In some embodiments, said indicators of compromise may have variable properties. Said variable properties may reflect the extent and severity, as well as the type of infiltration. An example of such variables may be the start time and delta of a certain action such as the implementation of or a change in a firewall rule. In certain embodiments, said indicators of compromise may undergo modifications representing the changes in some properties thereof, before the merge operation with an initial forensic image. An example case is as follows: Let x be a variable of an indicator of compromise. X may represent the start time of a certain process, and a user has the opportunity to alter and/or set said variable. Said variable property may also be preset for the indicator of compromise itself so that a modification of said property may reflect the attack time, whereby a more realistic simulation based on an attack scenario may be created.

In a merged view of the forensic snapshot, expected and normal processes may be viewed along with injected processes that are added later to the image as a simulation of evidence. Said merged view is then assigned to an analysis entity capable of viewing and determining the presence and the type, as well as the extent of a compromise or an infiltration. Any analysis entity is expected to respond to different types of indicators of compromise in different levels of alertness. As such, different analysis entities will be equipped to detect certain types of attack scenarios more precisely and accurately than others. These attack scenarios, namely techniques (of cyberattacks), will be the strengths of some analysis entities whereas other techniques may be strengths of other entities in an SOC. Disclosed technique thus offers a method of skill assessment in an SOC comprising multiple analysis entities.

Once merged views of multiple IoC-injected forensic snapshots are assigned to said analysis entities, strengths for detecting aforementioned techniques are ranked for each analysis entity. This strength rankings result in a skill assessment profile for each analysis entity in an SOC, enabling the SOC to be structured in a more efficient and robust manner that is more suitable for ensuring greater security and alertness against attacks such as advanced persistent threats, APTs. Said skill assessment profiles may later be utilized for training of respective analysis entities targeted for their improvement in recognizing and responding to certain types of techniques associated with various indicators of compromise.

In some cases, certain attack scenarios may involve multiple assets being compromised with different IoC's. A SOC managed according to the disclosed readiness ensuring method will comprise different analysis entities capable of responding to different facets of an attack in an optimum manner, ensuring greater security of the information system/network.

In various embodiments, what the disclosed method targets an information system network comprising at least multiple assets. Said network also comprises at least one asset configured to implement at least a set of security-related properties and actions stored in said storage medium. According to an embodiment, said processor is configured to collect a forensic snapshot comprising at least a set of predefined or user-defined parameters related to the operational state of at least one asset at the beginning and the end of a predetermined time interval.

According to various embodiments, said indicators of compromise may include several types of events. A change to a type of golden image or an initial baseline forensic image associated with a type of asset may be categorized with authentication breaches, registry edits, disk writes, copy actions, exfiltrations and the like. Such categorizations may be predetermined, or user-determined, and may be based on rules. Said rules can enable endpoint agent monitors and other authorized agents to categorize different actions such as allowable benevolent actions, unallowable malicious actions, and unknown events. For example, an event such as a security update to a member in the information system/network may be identified as an allowable benevolent event, whereas previously identified, known malware can be identified as a malicious event that is not allowable. Even though the aforementioned asset from which the forensic snapshot was taken doesn't contain any of these alerts/evidence, merged forensic snapshots with injected indicators of compromise provide a simulated view of this asset that is hard to differentiate compared to a real world attack.

According to an aspect of the present disclosure, a method of digital forensics investigation suitable for a security operation center comprising at least multiple analysis entities is proposed. Said operation center may be configured to monitor at least one information network comprising at least multiple assets

According to an aspect of the present disclosure, said method of digital forensics investigation comprises a step of forensic artifact collection, wherein multiple forensic snapshots pertaining to the baseline operational state of at least multiple assets are created based on predetermined characteristics of the device that may be based on properties of that specific asset or its use case, said snapshot being selectable from a group of binary or text formats including, but not limited to, CSV, JSON, plaintext, or log file.

According to an aspect of the present disclosure, said method of digital forensics investigation comprises a step of compromise indicator injection, wherein said multiple forensic snapshots are injected with indicators of compromise associated with at least one type of infiltration of at least one asset, representing a potential compromise or an attack scenario.

According to an aspect of the present disclosure, said method of digital forensics investigation comprises a step of investigation rating, wherein said at least multiple analysis entities are rated in multiple categories based on their performance for identifying injected forensic snapshots and associating said forensic snapshots with types of malicious activity,

According to an aspect of the present disclosure, said method of digital forensics investigation comprises a step of readiness-based grouping, wherein said at least multiple analysis entities that are rated in multiple categories are grouped based on predetermined standards for a security operation center.

According to an aspect of the present disclosure, said multiple categories said multiple analysis entities are rated in correspond to cyberattack techniques as associated with said attack scenarios created in the compromise indicator injection step.

According to an aspect of the present disclosure, said multiple categories said multiple analysis entities are rated in are more than two.

According to an aspect of the present disclosure, said multiple categories said multiple analysis entities are rated in are four.

According to an aspect of the present disclosure, said method further comprises a step of training suggestion, wherein said at least multiple analysis entities that are rated in multiple categories are suggested for training based on their weaker categories that are observed to be below a predetermined threshold.

According to an aspect of the present disclosure, said indicators of compromise are selected from a collection of threat groups documented according to the MITRE ATT&CK framework.

According to an aspect of the present disclosure, said indicators of compromise are selected from known enterprise-level techniques, such as those of APT28.

It should be understood that other embodiments and examples may provide similar functions and similar results with the included embodiments of the present invention. All such cases are in the domain of the present disclosure.

1. A method of digital forensics investigation suitable for a security operation center comprising at least multiple analysis entities, said operation center being configured to monitor at least one information network comprising at least multiple assets, comprising steps of;
forensic artifact collection, wherein multiple forensic snapshots pertaining to the baseline operational state of at least multiple assets are created based on predetermined characteristics of the device that may be based on properties of that specific asset or its use case, said snapshot being selectable from a group of binary or text formats including, but not limited to, CSV, JSON, plaintext, or log file,
compromise indicator injection, wherein said multiple forensic snapshots are injected with indicators of compromise associated with at least one type of infiltration of at least one asset, representing a potential compromise or an attack scenario,
investigation rating, wherein said at least multiple analysis entities are rated in multiple categories based on their performance for identifying injected forensic snapshots and associating said forensic snapshots with types of malicious activity,
readiness-based grouping, wherein said at least multiple analysis entities that are rated in multiple categories are grouped based on predetermined standards for a security operation center.

2. A method of digital forensics investigation suitable for a security operation center as set forth in claim 1, wherein said multiple categories said multiple analysis entities are rated in correspond to cyberattack techniques as associated with said attack scenarios created in the compromise indicator injection step.

3. A method of digital forensics investigation suitable for a security operation center as set forth in claim 1, wherein said multiple categories said multiple analysis entities are rated in are more than two.

4. A method of digital forensics investigation suitable for a security operation center as set forth in claim 1, wherein said multiple categories said multiple analysis entities are rated in are four.

5. A method of digital forensics investigation suitable for a security operation center as set forth in claim 1, wherein said method further comprises a step of training suggestion, wherein said at least multiple analysis entities that are rated in multiple categories are suggested for training based on their weaker categories that are observed to be below a predetermined threshold.

6. A method of digital forensics investigation suitable for a security operation center as set forth in claim 1, wherein said indicators of compromise are selected from a collection of threat groups documented according to the MITRE ATT&CK framework.

7. A method of digital forensics investigation suitable for a security operation center as set forth in claim 1, wherein said indicators of compromise are selected from known enterprise-level techniques, such as those of APT28.
